(19) United States
(12) Patent Application Publication
(10) Pub. No.: US 2005/0044168 A1
(43) Pub. Date: Feb. 24, 2005

(54) Method of connecting a plurality of remote sites to a server

(75) Inventors: Hwee Hwa Pang, Singapore (SG); Lim Soon Wong, Singapore (SG); Mun Kew Leong, Singapore (SG)

Correspondence Address: CONLEY ROSE, P.C., P. O. BOX 3267, HOUSTON, TX, 77253-3267, US

(73) Assignee: Agency for Science Technology and Research, Singapore (SG)

(21) Appl. No.: 10/497,237

(22) PCT Filed: Dec. 3, 2001
(86) PCT No.: PCT/SG01/00244

(51) Int. Cl. G06F 15/16

(52) U.S. Cl. 709/217

(57) ABSTRACT

Remote sites are connected to a server located on a computer network. One or more of the remote sites sends a request to connect to the server. The server then provides one or more server processes to allow connection and subsequent transfer of data between the server and the remote site. After connection, the server provides for the collection of utilisation information concerning utilisation of one or more server resources. The utilisation information can be processed to provide for modification in the number of server processes to ensure that one or more of the resources used by the server operate at a pre-determined utilisation.

### FIELD OF THE INVENTION

This invention broadly relates to a server for and method of connecting a plurality of remote sites. The invention also broadly relates to a system for managing a plurality of servers. This invention has particular but not exclusive application to the management and operation of an Internet or “web” server.

### BACKGROUND

Internet servers act as connection points to the Internet; they are nodes or junctions connecting remote sites to the rest of the Internet. Typically, an Internet or “web” server has at least one scheduler process and a number of server processes. The scheduler process listens for requests on a designated network port, typically 80 or 8080. When a request from a remote site is detected the scheduler attempts to assign the request to an idle server process. If this connection fails then the scheduler may choose to spawn a new server process to meet the request; alternatively the request can be queued until one of the existing server processes becomes free. Servers typically have set upper and lower boundaries limiting the number of available server processes. The upper limit prevents the web server from monopolising system resources and the lower limit ensures there is a sufficient number of server processes available to give remote sites a sufficient response time.

The number of server processes in a web server should be high enough to allow concurrent processing thereby providing for full exploitation of the available system resources. Unfortunately, excessive concurrency tends to be detrimental to the system performance because of the problems encountered by increased context switching and resource and data contention. Hence, In practice it is extremely difficult to establish an optimal setting The optimal configuration depends on a number of variables including the machine configuration, the request mix and the processing characteristics of the web application. Many administrators therefore choose to either tune this parameter by trial and error or simply accept the default setting. Acceptance of the default setting tends to result in either too many or too few server processes

Internet servers typically process requests on a first come first serve basis; that is remote sites are connected in the order in which they request their connections. The process of allocating remote sites to the server on this basis does to some extent ensure fair service where there is a light demand; in these circumstances there is typically only a short wait, and the order in which each remote site is connected does not cause great concern.

As the number of remote sites requesting connections increases the server becomes busier and subsequently the waiting time for requests from remote sites to be fulfilled increases. In some cases the remote site may abort the attempted connection, or the server may time-out, this may even occur while the request is being processed. This wastes resources that have been committed to the request, and causes the remote site to attempt another connection. When request resubmissions occur frequently, the resource wastage can lead to an even greater degradation in the performance of the overloaded server.

Overloading of a server may occur through a genuine demand on the server or through a deliberate malicious attack. Servers according to the prior art have been known to be open to attacks in which continuous TCP/IP packets are sent to the server. This results in the consumption and subsequent depletion of server resources followed by either hanging or crashing of the server.

The malicious sending of data in this way is termed a “denial of service” attack. This kind of attack may target various levels of the server. A common form of service attack is the SYN attack. This is a network level attack where the attacker sends continuous TCP SYN packets to a server with each TCP SYN packet hanging the server. This consumes the capacity of the server processes until there are no more TCP resources available. Another more sophisticated denial of service attack occurs above the network level at the web server level. In these attacks a connection is requested and the web server opens the connection and waits for data; this data is never sent. Thee time spent by the server waiting utilises resources that would otherwise be used for handling other requests. Even though the server eventually frees up the resources by timing out the connection, there is still a problem when a large number of these “uphantom” requests are received over a sustained period of time.

A number of filtering products have been developed which attempt to relieve the problems with the overloading of servers by attackers. One commonly used filtering product is a firewall; this provides a perimeter form of defence for securing network access. There are two types of firewalls commonly available.

The first and most common is a packet filtering firewall. This type of firewall can protect against SYN denial of service attacks that occur at a network level. A packet filtering firewall will however not be as efficient in protecting against a denial of service attack at the server level. The second type of firewall is a proxy or application firewall which provides a more sophisticated form of protection. This firewall can protect against SYN denial of service attacks as well as some attacks at the server level. These application firewalls, such as HP Praesidium e-Firewall, have a high degree of functionality and accordingly can provide a first line of protection against denial of service attacks at a server level.

A product which complements these typical application firewalls is WebQos. This application receives and examines all requests at a server level and analyses each data packet before forwarding the data on to the server. The application will not pass the request on to the web server unless there is legitimate data associated with the request. This prevents the web server being affected by denial of service attacks at a server level thereby allowing the server to go on and process legitimate requests. Both the firewalls and complementary products however do little to manage the conduct of legitimate requests from remote sites.

The object of the present invention is to address some or all of the disadvantages present in the prior art.

### SUMMARY OF INVENTION

In a first aspect the present invention provides a method of connecting a plurality of remote sites to a server located on a computer network, the method including the steps of:
one or more remote sites sending a request to connect to the server;
the server providing one or more server processes wherein each server process allows connection and subsequent transfer of data between the server and the remote site connected to the server via that server process;
connecting one or more of the remote sites to the server via one of the server processes;
collecting utilisatlon information, utilisation information being information concerning utilisation of one or more resources used by the server to operate; and
processing the utilisation information and modifying the number of server processes provided wherein the number of server processes is modified to ensure one or more of the resources used by the server operate at a pre-determined utilisation.

This aspect of the present invention provides an advantage in ensuring that the server operates under optimal conditions regardless of the load experienced. It also has the further advantage of providing a server that has capability to automatically control the number of processes available rather than relying on trial-and-error tuning or inappropriate standardised settings.

Preferably, upon the server receiving the request to connect, each request to connect is queued in an order corresponding to a priority allocated to each remote site, thereby determining the order in which each request to connect will be connected to the server.

When the server receives the request to connect from a remote site, the server may allocate the request to one of a plurality of queues wherein the server connects requests in a pre-determined queue in preference to requests in one or more other queues. These request to connect may be allocated to a queue corresponding to a priority allocated to one or more remote sites.

The queuing of requests allows the server to provide preferential service to favoured users. This allows a server to focus on servicing priority users if desired rather than accepting sessions indiscriminately and providing unacceptable response times.

In an alternative or additional form, the method includes the following preferred steps:
the connection is made between the remote site and the server via one of the server processes;
the remote site nominates a location on the network from which to receive data;
the server provides the remote site with data from one of a plurality of document trees corresponding to the location wherein each document tree represents an alternative view of information contained at the location; and
the server switches between document trees depending on the queue in which the request to connect was placed.

Preferably, upon receipt of the request to connect, the server examines the request to connect and allocates it to a queue depending on a predetermined priority allocated to the request to connect.

In a further alternative or additional form, the method includes the following preferred steps:
the server receives the request to connect from a remote site;
the server examines the request;
the server may allocate the request to one of a plurality of queues wherein the server connects requests in a predetermined queue in preference to requests in one or more other queues. These requests to connect may be allocated to a queue corresponding to a priority determined by an examination of the request.

The queuing of requests based on an examination of the request allows the server to provide preferential service based on characteristics of the request. This allows the server to provide preferential service to non-predetermined remote sites if desired and to service similar requests within the same context to reduce or minimise context switching.

Upon the server receiving the request to connect from a remote site, the request may be examined and categorised to allocate the remote site to a queue that corresponds to a priority determined by the examination request. The server may also allocate the request to a queue on the basis of a pre-determined priority allocated to the remote site.

In a second aspect the present invention provides a method of connecting a plurality of remote sites to a server located on a computer network, the method including the steps of:
one or more remote sites sending a request to connect to the server;
the server providing one or more server processes wherein each server process allows connection and subsequent transfer of data between the server and the remote site connected to the server via that server process;
queuing a plurality of requests to connect, each request to connect being queued in an order according to a priority determined by the server thereby determining the order in which each request to connect will be connected to the server; and
connecting one or more of the remote sites to the server via one of the server processes in an order corresponding to the order of the queue.

Where a plurality of queues are formed the server may allocate the request to connect to one of this plurality of queues wherein the server connects requests in a pre-determined queue in preference to requests in one or more other queues.

The method of the first or second aspect of the invention may further include the optional steps of:
predicting a response time for the remote site that has sent a request to connect, the response time being the time for the server to fulfill the request from the remote site;
determining a timeout time for the remote site, the timeout time being the time until the request to connect will expire; and
comparing the response time to the timeout time and refusing a request where the request to connect is likely to expire before the request is fulfilled by the server processes.

In one form of the invention the comparison of response time and timeout time is done at any time before the remote site connects to the server via a server process. The comparison of response time and timeout time may also be made immediately after the server receives the request to connect from the remote site.

In a further preferred form of the invention, information as to the response time and timeout time is continuously updated and a continuous comparison made between response time and timeout time until either the request to connect is refused or a connection is made to the server via a server process.

Where the remote site is refused a connection the server may send a re-request protocol, the re-request protocol providing a means whereby another request for connection is automatically sent to the server after a pre-determined time.

A still further particularly preferred form of the present invention provides a method including the further steps:
the connection is made between the remote site and the server via one of the server processes;
the re-request protocol designates a location on the network from which the remote site can retrieve the results requested; and
the server schedules a server process to fulfil the request and deposit the results at the designated network location before the remote site is scheduled to return.

The server may monitor the response time of one or more requests to connect, the response time being the time between making a request to connect and the fulfillment of the request via one of the server processes; and the server may switch between document trees depending on the response time.

In another preferred form of the invention the server switches between document trees to optimise the response time for one or more remote sites.

In a third aspect the present invention provides a server for connecting remote sites to a computer network, including;
means to receive a request to connect from a remote site;
one or more server processes wherein each server process allows connection and subsequent transfer of data between the server and the remote site connected to the server via that server process;
means to connect a remote site to the server via one of the server processes;
a monitoring subsystem, the monitoring subsystem providing for the collection of utilisation information being information concerning utilisation of one or more resources used by the server to operate; and
a switching subsystem, the switching subsystem receiving utilisation information from the monitoring subsystem and acting to control the number of server processes available on the server wherein the number of server processes is modified to ensure one or more resources used by the server operate at a predetermined utilisation.

Preferably, the server includes a queuing sub-system. The queuing sub-system queues requests to connect from a plurality of remote sites, the requests to connect being queued in an order corresponding to the order in which each request to connect will be connected to the server.

The queuing sub-system may provide a plurality of queues, the server allocating the request to connect to one of a plurality of queues wherein the server connects requests in a pre-determined queue in preference to requests in one or more other queues. In one form of the invention one or more requests to connect are allocated to a queue according to a priority determined by the sub-system.

Upon receipt of the request to connect, the queuing subsystem may examine and allocate the request to a queue which corresponds to a priority determined by examination of the request The request to connect may also be allocated to a queue based on information including a pre-determined priority allocated to the remote site sending the request to connect.

In a fourth aspect the present invention provides a server for connecting remote sites to a computer network, including;
means to receive a request to connect from a remote site;
one or more server processes whereby each server process allows connection and subsequent transfer of data between the server and the remote site connected to the server via that server process;
means to connect a remote site to the server via one of the server processes;
a queuing sub-system, the queuing sub-system providing a means to queue one or more requests to connect, each request to connect being queued in an order corresponding to a priority allocated to each remote site thereby determining the order in which each request to connect will be connected to the server; and
connecting one or more of the remote sites to the server via one of the server processes in an order corresponding to the order of the queue.

Where a plurality of queues are formed, the server may allocate the request to connect to one of the plurality of queues wherein the server accepts requests to connect in a predetermined queue in preference to requests in one or more other queues.

In one still further form of the invention the server includes the following additional features:
a means for predicting a response time for a request from a remote site to be fulfilled by the server;
a means for determining the timeout time of a remote site, the timeout time being the time until the request to connect will expire;
a termination sub-system wherein the response time is compared to the timeout time and a request to connect is refused by the server where the request to connect is likely to expire before the request is fulfilled by a server process.

The comparison of response time and timeout time may be done at any suitable time. A particularly preferred time for comparing the response time and timeout time is before the remote site connects to the server via a server process. The comparison of response time and timeout time may also be made immediately after the server receives the request to connect from the remote site.

Information as to the response time and timeout time may be continuously updated allowing for a continuous comparison to be made between the response time and the timeout time until the request to connect is either refused or a connection is made to the server via a server process.

Where a remote site is refused a connection any suitable protocol may be followed. In one preferred form, upon refusal of a request to connect the server sends to the remote site a re-request protocol, the re-request protocol providing a means whereby another request for connection is automatically sent to the server after a pre-determined time.

An alternative or additional form of the server according to the present invention includes a plurality of document trees accessible to the server. Each document tree represents an alternative view of information contained at a location on the computer network.

In a further alternative or additional form the server may include the additional components of:
a means for predicting a response time for a remote site to connect to the server
a document tree switching subsystem whereby the server switches between document trees depending on the response time.

Where multiple document trees are provided the server may additionally switch between document trees to optimise the response time for one or more remote sites. This may involve further components that are suitable for this purpose. The switching may be accomplished by the following further optional components:
means for predicting a response time for a remote site to connect to the server,
a document tree switching sub-system wherein the server switches between document trees depending on the queue in which the request to connect was placed.

In a fifth aspect the present invention provides a system for managing a plurality of servers, including:
a plurality of servers;
a controller, wherein the controller receives requests to connect from a remote site and routes the requests to one of the servers;
a server monitoring sub-system, the server monitoring sub-system monitoring utilisation of one or more resources used by one or more of the servers to operate; and
a server switching subsystem, the server switching subsystem receiving utilisatlon information from the server monitoring subsystem and acting to control the number of server processes available on the server and/or number of servers available to connect to remote sites wherein the number of server processes and/or number of servers available is modified to ensure one or more resources used by one or more of the servers operate at a pre-determined utilisation.

In a sixth aspect the present invention provides a system for managing a plurality of servers, including
a plurality of servers;
means to receive a request to connect from a remote site and route the request to connect to one of the plurality of servers which are available to receive a request to connect; and
a server queuing sub-system wherein requests to connect from a plurality of remote sites are queued in an order corresponding to the order in which each request to connect will be routed to the next available server.

Preferably, the queuing sub-system provides a plurality of queues, each request to connect being allocated to one of the plurality of queues wherein the server connects requests in a pre-determined queue in preference to requests in one or more other queues.

The requests to connect may be allocated in any suitable manner. A particularly suitable manner is by allocating a request to connect to a queue according to a priority allocated to one or more of the remote sites, or by examination of the request to connect, or by a combination of the two.

In a particularly preferred form of the invention the system includes the further components of:
a means for predicting a response time for a request from one or more of the remote sites to be fulfilled by a server;
a means for determining the timeout time of a remote site, the timeout time being the time until the request to connect will expire;
a termination subsystem wherein the response time is compared to the timeout time and a request to connect is refused by the server where the request to connect is likely to expire before the request is fulfilled by a server.

The comparison of response time and timeout time can be done at any suitable time. A particularly suitable time to compare these variables is at any time before the remote site connects to the server via a server process.

Additionally or alternatively, the response time and timeout time may be continuously updated and a continuous comparison made between the response time and the timeout time until either the request to connect is refused or a connection is made to the server.

In yet another form of the invention, one or more of the servers of the system sends a re-request protocol to the remote site, the re-request protocol providing a means wherein another request for connection is automatically sent to the server after a pre-determined time

Where the connection is made between the remote site and the server via one of the server processes and the re-request protocol designates a location on the network from which the remote site can retrieve the results, the server may have means to schedule a server process to fulfil the request and deposit the results at the designated network location before the remote site is scheduled to return.

The invention will now be described in further detail by reference to examples. It is to be understood that the particularity of the following examples does not supersede the generality of the foregoing description

### BRIEF DESCRIPTION OF DRAWINGS

The invention will now be described in further detail by reference to the enclosed drawing illustrating an example form of the invention. It is to be understood that the particularity of the drawing does not supersede the generality of the preceding description of the invention. In the drawing;

FIG. 1 is a schematic diagram illustrating the system architecture of one embodiment of the present invention.

FIGS. 2 & 3 illustrate algorithms that illustrate aspects of the present invention.

FIG. 4 is a schematic diagram illustrating the system architecture of a further embodiment of the present invention.

### DETAILED DESCRIPTION

The present invention provides a number of mechanisms that may be used to improve the performance of a web server. These mechanisms may be implemented either in web servers directly or integrated into associated software products.

The invention may deploy load monitors for critical system resources such as server CPUs, hard disks and network adapters. The number of server processes may then be set to ensure the load of critical or the most heavily utilised resources is within an acceptable range. For example, new server processes may be spawned for waiting requests to connect where the load is below the desired range, and free server processes may be terminated where the load is over the acceptable range. The inventors have found that it is particularly desirable to keep the critical resource within a 60% to 70% utilisation.

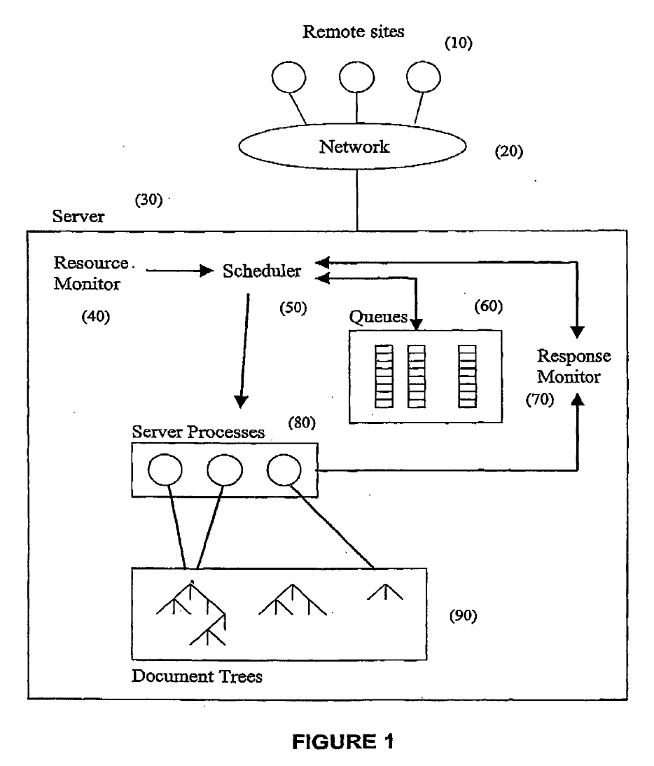

The components of one form of the present invention are illustrated in FIG. 1. The remote sites 10 are connected to the network 20 that facilitates the connection to the server 30. Within the server there is provided a resource monitor and response monitor 70, this monitors loading of the server and provides information which can be used to control operation of the server. Any requests from the remote sites 10 can be queued 60, the schedule 50 can then dictate which requests will be actioned by the server processes 80. Where multiple document trees are provided for a particular set of information requested by the remote site then the server process can then choose which document tree 90 to provide.

The invention may accord priority to remote sites requesting a connection in a range of ways. For example, this may occur in web applications such as on-line banking and electronic customer relationship management where a request to connect has been sent then further follow-on requests are issued during the session. In at least one embodiment of the invention follow on requests can be given priority over new requests. This ensures that those who are currently utilising the server have access to the server rather than the server taking on further request that are likely to overload the system resulting in additional slowing of service to those remote sites already connected. Where an ordered list of service queues together with selection criteria for each queue is defined then each request can be allocated to a queue for which it qualifies. This allows the web server to attend to requests in the highest priority queue before moving onto requests from other queues. Each request to connect may be prioritised in any suitable manner; for example re-issued requests may be favoured over new requests resulting in a prioritising of requests by the number of connection attempts.

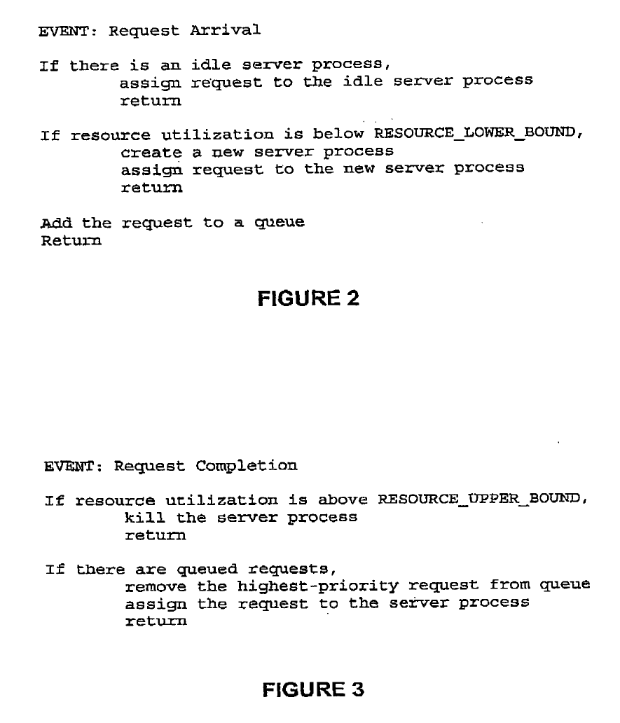

Algorithms that model the arrival of a request and completion of a request are shown in FIGS. 2 & 3. FIG. 2 illustrates the situation where the event is “request arrival”, that is a request arrives then it will be assigned to an idle server process. However, where resource utilisation is below a predetermined value then a new server process will be spawned. FIG. 3 illustrates the situation where the event is “request completion”, that is where a request has been assigned and completed. If utilisation of the resources is above a pre-determined value then a server process will be killed. Alternatively, where there are queued requests the highest priority request will be removed from the queues and assigned to the server process.

The invention may also accord priority to a request to connect based on an examination of the request itself. For example, HTML pages on many web sites and web applications contain a mix of text and non-text. One example of this is the provision of text information and images. The inventors have found that users tend to be satisfied where the the text portion is presented first with the non-text portion being presented at a later time. A http request to retrieve information such a HTML page can be divided into requests for the text portions and requests for the non-text portions. By examining the requests, the server is able to queue the requests for text portions at a higher priority. This ensures that more users are able to receive the text portions earlier and faster than would otherwise be the case.

The invention may also include a facility to deal with the deferring or rejecting of requests to connect. Instead of queuing incoming requests until they are timed out, a queued or newly arrived request may be rejected if the system expects the request to time out. This provides a facility where a remote site can be informed quickly of an overload situation and invited to return later. The system may employ various techniques to predict the response time for a request. One suitable method is by multiplying the average observed response time by the number of requests that are ahead in the queue or queues.

The invention may also provide the facility to defer a request rather than rejecting it. This deferment may be done by automatically returning a meta-refresh HTML page to the remote site. This meta-page will contain parameters of the request as well as a delay time that will cause the browser of the remote site to automatically re-issue the request after a specified delay. This delay may correspond to the estimated time for servicing all the higher priority and/or earlier requests.

The invention may also provide for the adaptation of returned results. This is where the system accepts one or more alternative document trees for the same web site. The document tree can be selected by analysing the time-out ratio and turnaround time of the server during operation. Where the server is experiencing heavy demand then a less data intensive document tree may be provided to the remote site. Allowing the server to dynamically switch to a less processing-intensive document tree aids in improving response time. Where this mechanism is combined with the queuing priority feature described earlier the invention can ensure that higher priority remote sites receive less degradation in service.

In a further embodiment the invention provides a system having a number of servers. A controller is set to receive requests and route them to one of the servers. The controller may also have the function of performing the load balancing and fail over functions. In one exemplary embodiment of the invention the dynamic setting of the number of server processes is employed by each individual server. The prioritising of requests, deferring or rejecting of requests and adapting of returned results as described above can then be done by the controller. The controller may also additionally or alternatively employ a mechanism to activate and deactivate servers allowing the rental of servers from a reserve pool offered by a third party such as an Internet Service Provider. Practically this may require modification of server properties such as the IP address. It may also require port assignment of switches to add/remove servers from the virtual local area network of the web server operator.

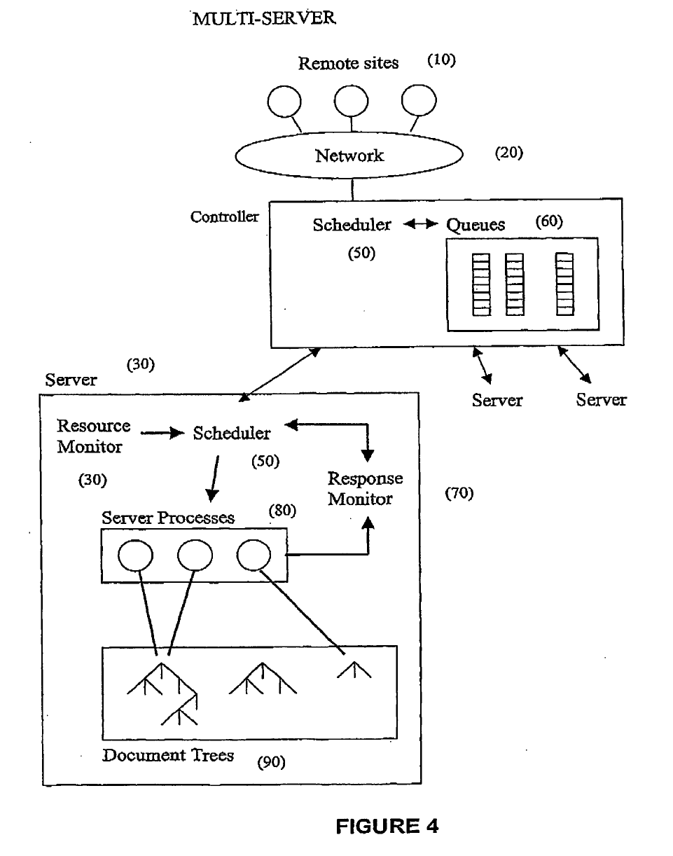

A system according to the present invention having multiple servers is illustrated in FIG. 4. The remote sites 10 are connected to the network 20. A controller including a schedule 50 and queue 60 operates to control connection between the servers 30.

While the present invention has been described in particular detail, it should be readily apparent to those of ordinary skill in the art that changes and modifications in form and details may be made without departing from the spirit and scope of the invention.

1. A method of connecting a plurality of remote sites to a server located on a computer network, the method including the steps of:
(a) one or more remote sites sending a request to connect to the server;
(b) the server providing one or more server processes wherein each server process allows connection and subsequent transfer of data between the server and the remote site connected to the server via that server process;
(c) connecting one or more of the remote sites to the server via one of the server processes;
(d) collecting utilisation information, utilisation information being information concerning utilisation of one or more resources used by the server to operate; and
(e) processing the utilisation information and modifying the number of server processes provided wherein the number of server processes is modified to ensure one or more of the resources used by the server operate at a pre-determined utilisation.

2. A method according to claim 1, wherein when the server receives the request to connect, the request is queued in an order corresponding to a priority allocated to each remote site thereby determining the order in which each request to connect will be connected to the server.

3. A method according to claim 1, wherein upon the server receiving the request to connect from a remote site, the server allocates the request to one of a plurality of queues wherein We server connects requests in a pre-determined queue in preference to requests in one or more other queues.

4. A method according to claim 3, wherein one or more requests to connect are allocated to a queue corresponding to a priority allocated to one or more remote sites.

5. A method according to claim 1, wherein upon the server receiving the request to connect from the remote site, the request is examined and categorised to allocate the remote site to a queue which corresponds to a priority determined by examination of the request.

6. A method according to claim 1 or 5, wherein upon the server receiving the request to connect from the remote site, the request is allocated to a queue on the basis of a pre-determined priority allocated to the remote site.

7. A method of connecting a plurality of remote sites to a server located on a computer network, the method including the steps of:
(a) one or more remote sites sending a request to connect to the server;
(b) the server providing one or more server processes wherein each server process allows connection and subsequent transfer of data between the server and the remote site connected to the server via that server process;
(c) queuing a plurality of requests to connect, each request being queued in an order according to a priority allocated to each remote site thereby determining the order in which each request to connect will be connected to the server; and
(d) connecting one or more of the remote sites to the server via one of the server processes in an order corresponding to the order of the queue.

8. A method according to claim 7, wherein upon receipt of the request to connect, the server examines the request to connect and allocates it to a queue depending on a predetermined priority allocated to the request to connect

9. A method according to claim 7, wherein when the server receives the request to connect, the request to connect is allocated to a queue based on information including a pre-determined priority allocated to the remote site sending the request to connect.

10. A method according to claim 7, wherein a plurality of queues are formed by the server, the server allocating each request to connect to one of the plurality of queues wherein the server connects requests in a pre-determined queue in preference to requests in one or more other queues.

11. A method according to any preceding claim, further including the steps:
(a) predicting a response time for the remote site that has sent a request to connect, the response time being the time taken for the server to fulfill the request from the remote site;
(b) determining a timeout time for the remote site, the timeout time being the time until the request to connect will expire; and
(c) comparing the response time to the timeout time and refusing a request where the request is likely to expire before it can be fulfilled by one of the server processes.

12. A method according to claim 11 wherein the comparison of response time and timeout time is done at any time before the remote site connects to the server via a server process.

13. A method according to claim 11 wherein the comparison of response time and timeout time is made immediately after the server receives the request to connect from the remote site.

14. A method according to claim 11 wherein information as to the response time and timeout time is continuously updated and a continuous comparison made between response time and timeout time until either the request to connect is refused or a connection is made to the server via a server process.

15. A method according to any one of claims 11 to 14 wherein upon refusal of a request the server sends a re-request protocol to the remote site, the re-request protocol providing a means whereby another request for connection is automatically sent to the server after a pre-determined time.

16. A method according to claim 15 wherein
(a) the connection is made between the remote site and the server via one of the server processes;
(b) the re-request protocol designates a location on the network from which the remote site can retrieve the results requested; and
(c) the server schedules a server process to fulfil the request and deposit the results at the designated network location at any time before the remote site is scheduled to return.

17. A method according to claim 16 wherein
(a) the server monitors the response time of one or more request to connect, the response time being the time between making a request to connect and the connection to a server via one of the server processes; and
(b) the server switches between a plurality of document trees depending on the response time, wherein each document tree represents an alternative view of information contained at the server.

18. A method according to claim 17 wherein the server switches between document trees to optimise the response time for one or more remote sites.

19. A method according to any one of claims 2 to 10 wherein
(a) the connection is made between the remote site and the server via one of the server processes; and
(b) the server switches between a plurality of document trees depending on the queue in which the request to connect was placed, wherein each document tree represents an alternative view of information contained at the server.

20. A server for connecting remote sites to a computer network, including:
(a) means to receive a request to connect from a remote site;
(b) one or more server processes wherein each server process allows connection and subsequent transfer of data between the server and the remote site connected to the server via that server process;
(c) a means to connect a remote site to the server via one of the server processes;
(d) a monitoring subsystem, the monitoring subsystem providing for the collection of utilisation information being information concerning utilisation of one or more resources used by the server to operate; and
(e) a switching subsystem, the switching subsystem receiving utilisation information from the monitoring subsystem and acting to control the number of server processes available on the server whereby the number of server processes is modified to ensure one or more resources used by the server operate at a predetermined utilisation.

21. A server according to claim 20 including a queuing sub-system, the queuing sub-system queuing requests to connect from a plurality of remote sites, the requests to connect being queued in an order corresponding to the order in which each request to connect will be connected to the server.

22. A server according to claim 21 wherein the queuing sub-system provides a plurality of queues, the server allocating the request to connect to one of a plurality of queues wherein the server connects requests in a pre-determined queue in preference to requests in one or more other queues.

23. A server according to claim 22 wherein one or more requests to connect are allocated to a queue according to a priority allocated to one or more remote sites.

24. A server according to claim 22 wherein upon receipt of the request to connect, the queuing subsystem examines and allocates the request to a queue which corresponds to a priority determined by examination of the request.

25. A server according to claim 23, wherein when the server receives the request to connect, the request to connect is allocated to a queue based on information including a pre-determined priority allocated to the remote site sending the request to connect.

26. A server for connecting remote sites to a computer network, including;
(a) means to receive a request to connect from a remote site;
(b) one or more server processes whereby each server process allows connection and subsequent transfer of data between the server and the remote site connected to the server via that server process;
(c) means to connect a remote site to the server via one of the server processes;.
(d) a queuing subsystem, the queuing subsystem providing a means to queue one or more requests to connect, each request to connect being queued in an order corresponding to a priority allocated to each remote site thereby determining the order in which each request to connect will be connected to the server; and
(e) connecting one or more of the remote sites to the server via one of the server processes in an order corresponding to the order of the queue.

27. A server according to claim 26 wherein a plurality of queues are formed with the server allocating the request to connect to one of the plurality of queues wherein the server accepts requests to connect in a predetermined queue in preference to requests in one or more other queues.

28. A server according to any one of claims 20 to 27, including:
(a) means for predicting a response time for request from a remote site to be fulfilled by the server,
(b) means for determining the timeout time of a remote site, the timeout time being the time until the request to connect will expire;
(c) a termination sub-system wherein the response time is compared to the timeout time and a request to connect is refused by the server where the request to connect is likely to expire before the request is fulfilled by a server process.

29. A server according to claim 28 wherein the comparison of response time and timeout time is done at any time before the remote site connects to the server via a server process.

30. A server according to claim 28 wherein the comparison of response time and timeout time is made immediately after the server receives the request to connect from tee remote site.

31. A server according to claim 28 wherein information as to the response time and timeout time is continuously updated and a continuous comparison made between the response time and the timeout time until the request to connect is either refused or a connection is made to the server via a server process.

32. A server according to any one of claims 28 to 31 wherein upon refusal of a request the server sends to the remote site a re-request protocol, the re-request protocol providing a means whereby another request for connection is automatically sent to the server from the remote site after a pre-determined time.

33. A server according to any one of claims 20 to 32 including a plurality of document trees accessible to the server, each document tree representing an alternative view of information contained at a location on the computer network.

34. A server according to claim 33 including;
(a) means for predicting a response time for a remote site to connect to the server; and
(b) a document tree switching sub-system wherein the server switches between document trees depending on the response time.

35. A server according to claim 34 wherein the server switches between document trees to optimise the response time for one or more remote sites.

36. A server according to any one of claim 21 to 27 including;
(a) a means for predicting a response time for a remote site to connect to the server, and
(b) a document tree switching sup-system whereby the server switches between document trees depending on the queue in which the request to connect was placed.

37. A system for managing a plurality of servers, including:
(a) a plurality of servers;
(b) a controller, wherein the controller receives requests to connect from a remote site and routes the requests to one of the servers;
(c) a server monitoring sub-system, the server monitoring sub-system monitoring utilisation of one or more resources used by one or more of the servers to operate; and
(d) a server switching subsystem, the server switching subsystem receiving utilisation information from the server monitoring subsystem and acting to control the number of server processes available on the server and/or number of servers available to connect to remote sites wherein the number of server processes and/or number of servers available is modified to ensure one or more resources used by one or more of the servers operate at a pre-determined utilisation.

38. A system for managing a plurality of servers, including:
(a) a plurality of servers;
(b) means to receive a request to connect from a remote site and route the request to connect to one of the plurality of servers which are available to receive a request to connect; and
(c) a server queuing sub-system wherein requests to connect from a plurality of remote sites are queued in an order corresponding to the order in which each request to connect will be routed to the next available server.

39. A system according to claim 38 wherein the queuing sub-system provides a plurality of queues, each request to connect being allocated to one of the plurality of queues wherein the server connects requests in a pre-determined queue in preference to requests in one or more other queues.

40. A system according to claim 39 wherein one or more requests to connect are allocated to a queue according to a priority allocated to one or more of the remote sites.

41. A system according to any one of claims 37 to 40, including:
(a) means for predicting a response time for a request from one or more of the remote sites to be fulfilled by a server;
(b) means for determining the timeout time of a remote site, the timeout time being the time until the request to connect will expire;
(c) a termination sub-system wherein the response time is compared to the timeout time and a request to connect is refused by the server where the request to connect is likely to expire before the request is fulfilled by a server.

42. A system according to claim 41 wherein the comparison of response time and timeout time is done at any time before the remote site connects to the server via a server process.

43. A system according to claim 41 wherein information as to the response time and timeout time is continuously updated and a continuous comparison made between the response time and the timeout time until the request to connect is either refused or a connection is made to the server.

44. A system according to any one of claims 41 to 43 wherein upon refusal of a request to connect, the server sends to the remote site a re-request protocol, the re-request protocol providing a means whereby another request for connection is automatically sent to the server from the remote site after a pre-determined time.

45. A system according to claim 44 wherein the connection is made between the remote site and the server via one of the server processes and the re-request protocol designates a location on the network from which the remote site can retrieve the results, the server has means to schedule a server process to fulfil the request and deposit the results at the designated network location before the remote site is scheduled to return.
